(19) United States
(12) Patent Application Publication
(10) Pub. No.: US 2016/0180723 A1
(43) Pub. Date: Jun. 23, 2016

(54) CONTEXT DERIVED BEHAVIOR MODELING AND FEEDBACK

(71) Applicant: Intel Corporation, Santa Clara, CA (US)

(72) Inventors: Igor Tatourian, Santa Clara, CA (US); Hong Li, El Dorado Hills, CA (US); Rita H. Wouhaybi, Portland, OR (US)

(21) Appl. No.: 14/579,196

(22) Filed: Dec. 22, 2014

(51) Int. Cl. G09B 5/00

(52) U.S. Cl. CPC G09B 5/00

(57) ABSTRACT

System and techniques for context derived behavior modeling and feedback are described herein. A set of data about an environment and a person may be obtained from a plurality of devices present in the environment. The plurality of devices may include sensors. A behavior may be identified based on a comparison of the set of data to a behavior model. A recommended action to address the behavior may be generated. The recommended action may be communicated to at least one party influenced by the behavior.

### TECHNICAL FIELD

Embodiments described herein generally relate to behavior modeling and more specifically to context derived behavior modeling and feedback.

### BACKGROUND

Devices, such as clocks, radios, computers, refrigerators, or other appliances, are often found throughout structures that people inhabit, work in, or otherwise use. More frequently, these devices include the capability to participate in networks, such as the Internet, to share and receive information. The collection of such networked devices may be referred to as the Internet of Things (IoT).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram illustrating an example of a system for context derived behavior modeling and feedback, according to an embodiment.

FIG. 2 is a functional diagram illustrating an example of a system for context derived behavior modeling and feedback, according to an embodiment.

FIG. 3 is a flow diagram illustrating an example of a method for context derived behavior modeling and feedback, according to an embodiment.

FIG. 4 is a block diagram illustrating an example of a machine upon which one or more embodiments may be implemented.

### DETAILED DESCRIPTION

An entity, such as a person or group of people, may wish to modify its behaviors to achieve a desired outcome. For example, a person may want to lose weight. However, it may be difficult to determine the behaviors that need to be modified to effectuate weight loss. For example, exercise alone may provide weight loss for one person, but not another. A combination of behavior modifications may be needed to accomplish the desired result. Making the problem more complex, many behaviors that help or hurt the achievement of the desired outcome may not be observable by, may not be readily recognizable to, or may be ignored by, interested parties for a variety of reasons. Some of these reasons may include the lack of specialized observation equipment (e.g., security cameras, etc.) in the places the entities inhabit or use, lack of understanding in behavior interactions, or inattention to common activities. The data collected from the IoT devices may allow a person to more easily identify a behavior if they are able to find relevant data.

As noted above, the prevalence of IoT devices is increasing. IoT devices may contain a variety of sensors (e.g., cameras, microphones, global positioning systems (GPS), telemetry, etc.) for a variety of purposes, such as a camera and microphone on a television set to allow video conferencing. Many of these sensors provide environmental information that may be used to observe a person. Such observations may facilitate behavioral analysis of entities, such as the person, in the environment. Such behavioral analysis may then facilitate interactions with the entities, such as helping the person assess their achievement of a goal (e.g., weight loss by eating right and exercising) or a vendor meeting a customer's needs (e.g., by suggesting a healthy menu in light of the family's taste preferences demonstrated by meals eaten).

In contrast to dedicated sensor networks (e.g., such as discrete security systems), often the sensor data of one IoT device is insufficient to provide enough information to determine the person's behavioral patterns. Moreover, several devices may capture discrete portions of the environment, but it may be difficult to determine which of these portions are relevant to the behavior of discrete entities in the environment, such as the person. A given data set may include a large number of data elements, and many of them may be irrelevant to a person's goals. For example, a person may wish to know how far they walked in a given day. The data providing an indication of distance may be contained in a data stream of a number of IoT devices. In an example, the data may be contained in data elements in a data stream from a GPS sensor in a smartphone or may be contained in data elements from a data stream from check-ins with a social networking site. Filtering this data manually may prove to be impractical.

A behavior analysis engine may be employed to interact with IoT devices and create a data set containing relevant data appertaining to an entity. This dataset may be used to identify entity behavior and provide interested parties, such as the entity, recommended actions to address the behavior. For example, the person may want to lose weight or eat healthier. The behavior analysis engine may compare an initial dataset to a behavior model (e.g., food consumption, physical activity, purchasing activity, etc.) containing attributes of a given behavior. The data elements not relating to the attributes may be filtered out, resulting in a filtered data set containing only relevant data. In the example in which the person wishes to lose weight or eat healthier, a behavior model describing preparing a meal may contain attributes of food selection, cooking, device usage, etc. For example, the data set may contain an observation of the person selecting and cooking food according to a recipe as well as an observation of the person gathering wood and starting a fire in a fireplace. The data regarding gathering wood and starting the fire will be filtered out of the data set while the data regarding selecting and cooking food according to a recipe will remain in the data set. The filtered data may then be analyzed by the behavior analysis engine to determine a behavior of the person. For example, the behavior identified may be the selection of food. The behavior analysis engine may recommend an action to address the behavior. For example, the person may select bacon fat as cooking oil and the behavior analysis engine may recommend the selection of olive oil as a cooking oil to address the behavior. Thus, the person may optimize their behavior when preparing food to, for example, lose weight. In an example, the data set of the observation may be augmented by an audible interaction (e.g., question and answer) between the behavior analysis engine and the person. The response by the person (e.g., via voice recognition) may provide additional details of the activity being observed. For example, the person may be cooking at the stove and the behavior analysis engine may ask, out loud, “what are you cooking?” The response, “sautéed broccoli,” gives the system the answer without complex visual or chemical analysis.

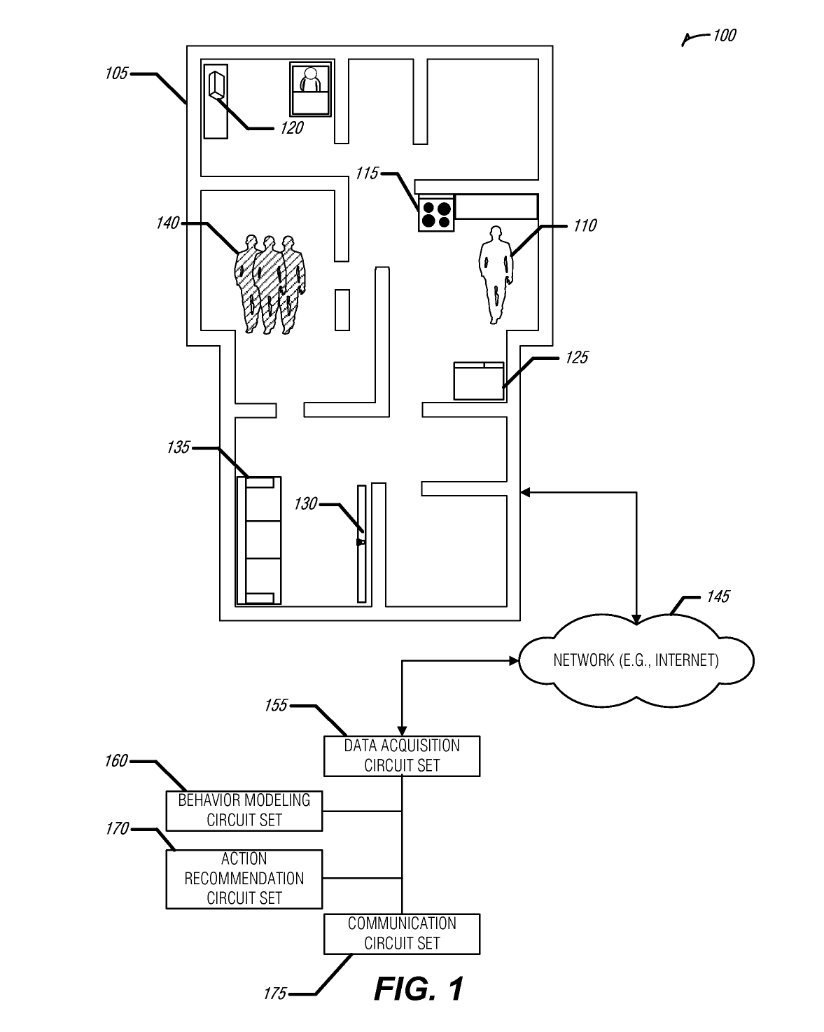

FIG. 1 is a block diagram illustrating an example of a system 100 for context derived behavior modeling and feedback, according to an embodiment. The system 100 may include a structure 105 (e.g., a living space, recreational space, work space, etc.), that includes a person 110, a plurality of IoT devices (e.g., smart appliances such as a stove 115 and refrigerator 125; a baby monitor 120; a smart electronic device such as a television 130; or smart furniture such as a sofa 135) communicatively coupled to a network 145 (e.g., the internet). The plurality of IoT devices may include sensors (e.g., an imaging sensor, an audio sensor, a part failure sensor, a telemetry sensor, a GPS sensor, etc.) (not shown). The structure 105 may also include a plurality of people 140 (e.g., friends of the person 110, family of the person 110, etc.). The system 100 may employ artificial intelligence technology (e.g., an expert system, a neural network, or the like) for data analysis and decision making. In an example, the system 100 may include a plurality of complex rule sets that when applied to a data set may generate new factual information that may be further used in the decision making process. For example, if a data set acquired by system 100 includes the person 110 selecting food and using the stove 115 the artificial intelligence technology of the system 100 may generate a new fact that the person 110 is cooking a meal.

The plurality of IoT devices may be located throughout the structure 105, may be detecting data about how an IoT device is used, and may observe the structure 105, the person 110, and the plurality of people 140.

Software sensors may be present internally or externally to the structure 105 to interface with online data sources (e.g., retailer websites, search providers, social media sites, etc.) containing data regarding the online activity (e.g., purchases, social media interaction, web search queries, etc.) of the person 110 or the plurality of people 140. The data collected may be indicative of the person's 110 and the plurality of peoples' 140 activities, moods, and usage patterns of the plurality of IoT devices.

As illustrated, the system 100 may include a data acquisition circuit set 155, a behavior modeling circuit set 160, an action recommendation circuit set 170, and a communication circuit set 175. Each of these may be communicatively coupled (e.g., wired or wirelessly when in operation) to the network 145. Each circuit set may be implemented individually or in combination in one or more physical or virtual machines (e.g., physical server(s), virtual server(s) running on physical host(s), cloud-based computing platforms, etc.).

The data acquisition circuit set 155 obtains a set of data about an environment (e.g., structure 105) and a person 110 from a plurality of devices present in the environment (e.g., the plurality of IoT devices). In an example, the environment includes at least one of a living area, a work area, or a recreation area. For example, the environment may be a home where the person 110 lives or an office complex where the person 110 works. In an example, the plurality of devices includes sensors. In an example, the plurality of devices including sensors includes at least one of a temperature sensor, an audio sensor, a motion sensor, or an image sensor. For example, refrigerator 125 may have a part sensor (e.g., a light sensor, an ice maker sensor, a water filter sensor, etc.) and a food sensor (e.g., an imaging sensor, an RFID sensor, etc.).

In an example, the IoT devices may contain software sensors. The data collected from the software sensors may be used to aid in the detection of attributes of the person 110. For example, examining social media (e.g., articles by the person 110 or others) may provide the person's 110 mood. In the example, the person 110 may have posted on a social media site that they are having a bad day. In the example, the social media posts may be combined with other collected indicia of mood (e.g., facial expressions, body language, biometrics, etc.) to, for example, determine the person 110 is sad.

The data collected from the software sensors and the sensors in the plurality of IoT devices may include indicia of usage patterns of an IoT device, the person's 110 activities and locations, related market information (e.g., where the person 110 shops, what kind of products the person 110 uses, etc.), time of the year, the weather, restaurant experiences, etc. The data collected may include data about the health of one of the plurality of IoT devices.

In an example, the person 110 is a member of the plurality of people 140 and the set of data includes data about the plurality of people 140. For example, the person 110 may be a child and the plurality of people 140 is a family unit of which the child is a member. In an example, the plurality of people 140 is determined by both a temporal and a proximal relationship between the person 110 and the plurality of people 140. For example, the plurality of people 140 may be a family unit determined by the plurality of people 140 sharing the structure 105 over a period of time. In an example, the person 110 may be a member of multiple groups. In the example, the multiple groups may be trying to optimize behavior of the person 110 to achieve a desired outcome. For example, a child whose parents are divorced may be a member of the family units of each parent.

The behavior modeling circuit set 160 identifies a behavior based on a comparison of the set of data to a behavior model. In an example, the analysis may look for short and long term patterns of behavior that may be compared to behavior models (e.g., purchasing behavior models, food consumption behavior models, activity behavior models, etc.). For example, a pattern of food habits (e.g., eats late at night, eats infrequent large meals, etc.) and dietary preferences (e.g., eats high caloric foods, eats a high fat diet, etc.) may be established by analyzing data received by the data acquisition circuit set 155 and analyzed against a behavior model with attributes associated with weight loss. In the example, the behavior model may contain several attributes including dietary restrictions and exercise schedules. The dietary restrictions may specify the maximum net caloric intake and recipes including more nutritious or lower calorie ingredients.

In an example, an examination of the data collected from software sensors linked to online data sources may be analyzed by the behavior modeling circuit set 160 to indicate a behavior related to online activity (e.g., social networking activity, writing restaurant reviews, conducting search queries, creating calendar entries, or making online purchases). For example, a person's 110 online purchasing habits (e.g., usually buys household goods from online retailer A) may be identified as a behavior by analyzing online activity of the person 110.

In an example, the behavior modeling circuit set may identify additional factors that may prompt changes in behavior. For example, the analysis of the behavior modeling circuit set 160 may identify additional factors indicative of changes in the person's 110 behavior (e.g., mood, the weather, the time of year, etc.). For example, the person may change food consumption habits or physical activities based on the weather. In the example, the person 110 may regularly eat vegetables as a snack; however, when it rains the person 110 may eat potato chips. In the example, the behavior modeling circuit set 160 will identify the weather as an input when identifying the behavior of the person 110.

In an example, the behavior may be identified by the behavior modeling circuit set 160 as the result of the person 110 choosing to take one action over another. For example, the person's 110 home (e.g., structure 105) may contain a refrigerator 125 that may be connected to the network 145 and may include a sensor that may detect when a water filter in its water filtration system needs replacement. The behavior model of the behavior modeling circuit set 160 may contain attributes of proper maintenance of the refrigerator 125. The person's 110 use of the refrigerator 125 and the data indicating that the water filter needs replacement may cause the behavior model to be selected as a match to the person's 110 desire to properly maintain appliances. The person's 110 failure to replace the filter, but rather watch the television 130, may be identified as the behavior.

In an example, a data element of the set of data includes at least one metadata element containing a characteristic of the data element based on the identified behavior. In an example, the data element may include metadata elements containing objective and subjective characteristics of the data element. For example, a cleaning product may contain an objective metadata element, such as a label that it disinfects, and a subjective metadata element, such as a label that the person 110 has an allergy to ingredient I of the cleaning product.

In the example where the person 110 is a member of multiple groups, the person 110's behavior may be tracked between the groups. For example, a child may be the member of two homes and the child's behavior may be tracked between both homes.

The action recommendation circuit set 170 generates a recommended action to address the behavior identified by the behavior modeling circuit set 160. For example, the behavior identified may be that the person 110 is eating unhealthy food. In the example, a recommended action may be generated to suggest the person 110 eat broccoli to address the behavior. In an example, the recommended action is based at least in part on the at least one metadata element. For example, the identified behavior may be cleaning the kitchen. In this example, a cleaning product P may have a metadata element of “disinfects” and a metadata element of “the person 110 is allergic to ingredient I in the cleaning product.” In this example, the recommended action may generate a list of cleaning solutions that may disinfect. However, cleaning product P may be filtered from the list based on the person's 110 allergy to ingredient I.

In an example, generating a recommended action may include the additional factors indicative of changes to the person's 110 behavior as identified by the behavior modeling circuit set 160. For example, in a climate where winter makes outdoor activity less desirable, the person 110 may be more sedentary during the winter and the recommended action generated by the action recommendation circuit set 170 may be to go for a walk in a local shopping mall or to join a local gym.

In an example, the information collected from software sensors may be used to alter the recommended action generated by the action recommendation circuit set 170. For example, the recommended action generated in response to a behavior identified as eat healthy may be a list of local health food restaurants A and B to visit when the person 110 is away from home during mealtime. However, the person 110 may have written a negative review of local health food restaurant A, so local health food restaurant A may be filtered from the list. In an example, the recommended action may be to complete an action the person 110 failed to complete. For example, if the person 110 watched television rather than replacing the water filter in refrigerator 125, the recommended action of replacing the filter may be generated.

The communication circuit set 175 communicates the recommended action to at least one party influenced by the behavior (e.g., the person 110, the plurality of people 140, a third party, etc.). As used herein, a party influenced by the behavior is a party (e.g., person, organization, etc.) with an identifiable interest in the behavior. Such identifiable interest may include a commercial interest, such as a vendor for the person 110, a personal interest, such as a relative or friend concerned about the person 110, an education interest, such as a teacher of the person 110, among others. For example, the person 110 may be a member of a group (e.g., the plurality of people 140) such as a family unit or a social group. In the example, the person's 110 bad eating habits may influence another member of the social or familial group to develop bad eating habits. In the example, the recommended action of, for example, eating broccoli may be communicated to the person 110 and the other members of the family unit. In an example, a different recommended action may be generated by the action recommendation circuit set 170 and communicated to each member of the group by the communication circuit set 175 that may be focused at changing the group member's individual behavior detected by the behavior modeling circuit set 160 to achieve the desired outcome.

In an example, the person 110 may be a member of multiple groups (e.g., child of divorced parents) and the recommended action may be communicated to members of each group. For example, a child of divorced parents may be a member of two family units. In the example, the members of each family unit may receive the recommended action of eat more broccoli to provide consistency for the child. In an example, the recommended action may be communicated to a wireless device. For example, the parents may receive a message including a list of ingredients including broccoli and a recipe including broccoli on a smartphone.

In an example, communicating the recommended action includes communicating the recommended action to a third party that has a relationship with the person 110 (e.g., buyer/seller, loyalty program provider/member, healthcare provider/patient, etc.). For example, the communication of a reminder to buy light bulbs may be communicated first to home improvement store L where the person 110 is a member of home improvement store L's loyalty program. In this example, the communication circuit set 175 receives a response to the communication from the third party. For example, home improvement store L may respond with a web link to purchase the light bulbs from the store's website or may respond with a coupon for the light bulbs that can be used in-store. In an example, this response may be used in a further communication with the person 110 or plurality of people 140. For example, the reminder to buy light bulbs may be modified to include the web link or coupon from home improvement store L.

In an example, sensor data may be communicated to third parties by the communication circuit set 175. For example, the inventory of refrigerator 125 including a food inventory sensor may be sent to a grocery store. In the example, the grocer may make recommendations or offers for products directly to the person 110 based on a relationship with the person (e.g., loyalty program member, registered user, etc.). In an example, the sensor data may be communicated to a third party based on a relationship between the person 110 and the third party. For example, the person 110 may be a member of grocery store C's loyalty program. In an example, the person 110 may wish to limit which third parties are able to receive sensor data or a recommended action to maintain privacy. For example, the person 110 may wish to allow home improvement store X to receive data, but not home improvement store Y regardless of relationships to either of the retailers. In another example, the person 110 may wish to allow grocery store A to receive data, but not grocery store B, because the person 110 is a member of the loyalty program of grocery store A. In another example, the person 110 may want to share data with her husband John, but not her mother Joan.

In an example, the data is aggregated and anonymized. For example, the usage statistics of the refrigerator 125 and the inventory may be sent to a third party that manufactured the refrigerator 125 without including any identifiable information of the person 110 so that the manufacturer may make product improvements to the refrigerator 125.

In an example, the person 110 may also wish to indicate which data is shared with each third party. In the example, the person 110 may customize the privacy level of each third party allowed to receive communications from the communication circuit set 175. For example, the person 110 may wish to share all data with John, but only recommended actions with home improvement store X.

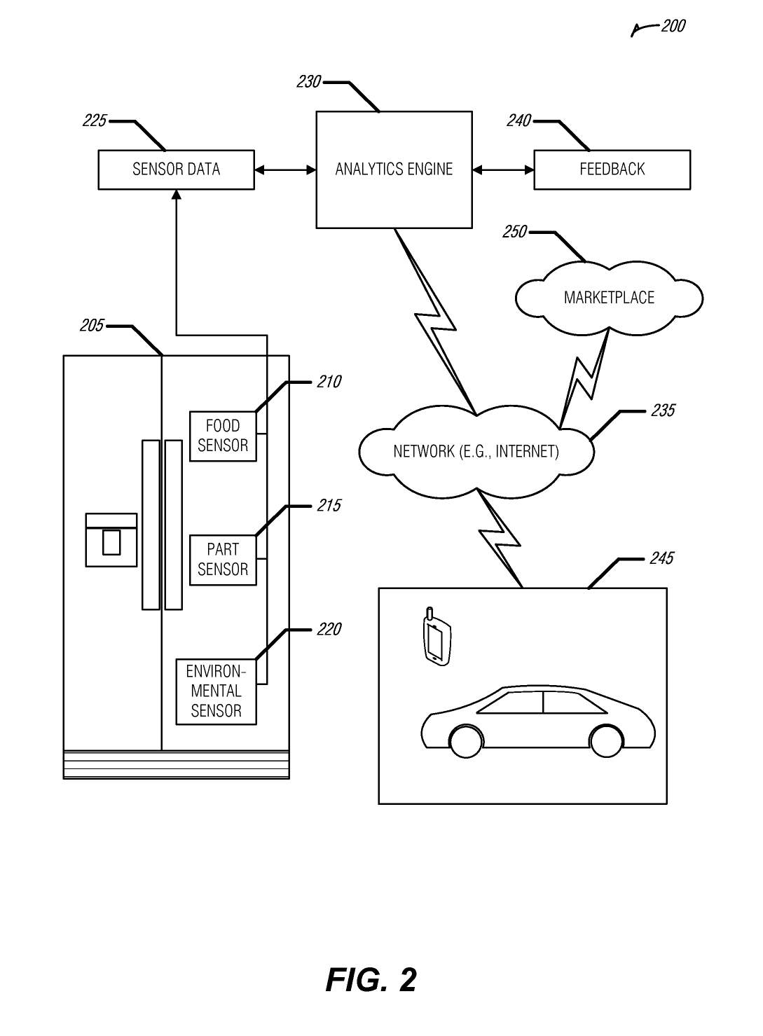

FIG. 2 illustrates a functional diagram of an example of a system 200 for context derived behavior modeling and feedback, according to an embodiment. The system 200 may operate similarly to the system 100 illustrated in FIG. 1. Accordingly, components in each system 100, 200 may perform one or more techniques described with respect to both systems 100 and 200. The system 200 may include a smart refrigerator 205. The system 200 may include a food sensor 210, a part sensor 215, and an environmental sensor 220 providing sensor data 225, which may be used as an input for the analytics engine 230.

The analytics engine 230 may output feedback 240 based on the analysis of the data collected from the sensor data 225. The analytics engine 230 may be communicatively connected to IoT devices 245 (e.g., a smartphone, an in-car entertainment system, etc.) via a network 235 (e.g., the internet). The analytics engine 230 may be communicatively connected to a marketplace 250 (e.g., online retailers, device manufacturers, healthcare providers, etc.) via the network 235.

The smart refrigerator 205 may include a plurality of sensors including at least one of the part sensor 215 (e.g., a light sensor, a shelf sensor, an ice maker sensor, a filter sensor, etc.), the environmental sensor 220 (e.g., thermometer, GPS, Wi-Fi, etc.) or the food sensor 210 (e.g., an imaging sensor, an RFID sensor, etc.). The plurality of sensors may be used to observe contextual information about the smart refrigerator 205, a person, and an environment (e.g., the operational health of the smart refrigerator 205, food consumption of the person, and nutrition information of food observed by the smart refrigerator 205, etc.). The smart refrigerator 205 may include an embedded computing device that is connected to the network 235. In an example, the computing device includes a user interface (e.g., a touchable display on the smart refrigerator's 205 door). In an example, the computing device may include software sensors that may observe a user's online activity, the user's usage pattern of the device, or the user's online or device-related habits. In an example, the analytics engine 230 may be implemented in the computing device in the smart refrigerator 205.

The sensor data 225 may be collected from the plurality of sensors and may include observations of the person or the environment including activity, mood, location, related market information, health, weather, date, time, restaurant experiences, calendar entries, or other contextual information. The sensor data 225 may be input for the analytics engine 230.

The analytics engine 230 may include several components, such as one or more of the data acquisition circuit set 155, the behavior modeling circuit set 160, the action recommendation circuit set 170, or the communication circuit set 175, described above with respect to the system 100. The analytics engine 230 may use the sensor data 225 to abstract patterns from the sensor data 225. The analytics engine 230 may output feedback 240 based on the abstracted patterns. For example, the feedback 240 may include icemaker broken, low in phosphorus, need juice for upcoming Friday party, carrots haven't been consumed for the past 7 days, a list of alternative foods to consider, or new refrigerator gadgets are available. In an example, analytics engine 230 may communicate with the marketplace 250 when outputting feedback 240. For example, the feedback 240 may include “buy part 1234 at online retailer A” or “buy a new gadget at online retailer Z.” In an example, the analytics engine 230 may consider contextual information (e.g., sickness, calendar entry, location, etc.). For example, a person may be in a vehicle with an IoT device 245 (e.g., an in-vehicle entertainment system) and may receive feedback 240 including part 1234 is available at home improvement store L 5 miles away or a grocery list for foods to be purchased at grocery store C on a display of the IoT device 245. In an example, the analytics engine 230 may include sharing abstracted patterns with the marketplace 250 to allow marketplace 250 participants to extract trends and provide consumers with promotions based on their needs.

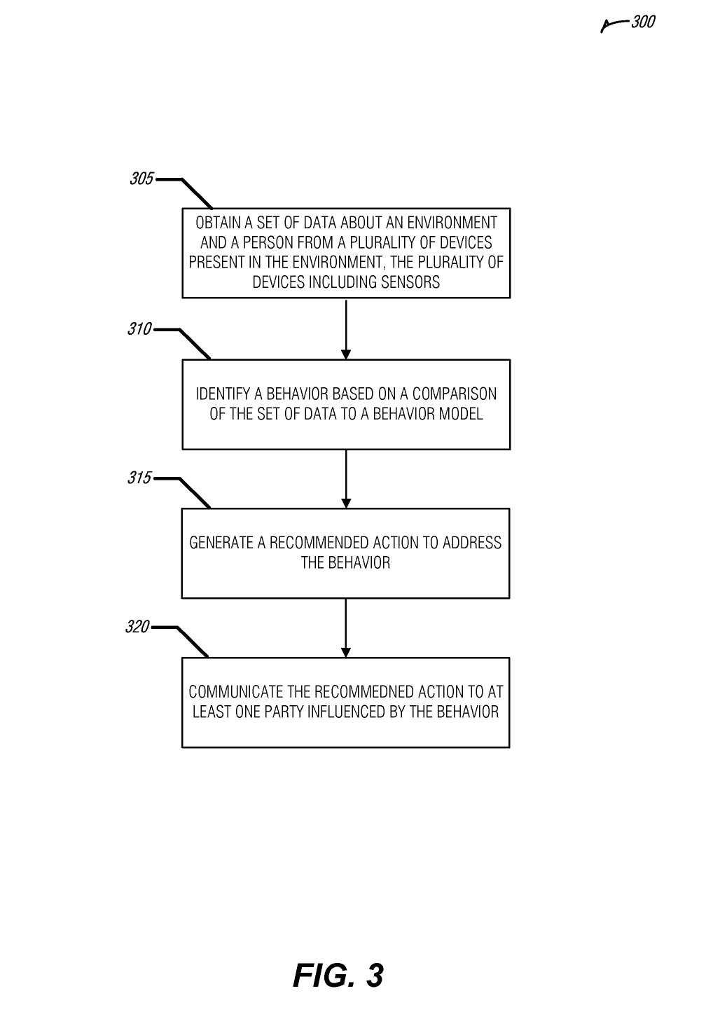

FIG. 3 illustrates a flow diagram of an example of a method 300 for context derived behavior modeling and feedback, according to an embodiment.

At operation 305, a set of data about an environment and a person is obtained from a plurality of devices present in the environment. In an example, the plurality of devices includes sensors. In an example, the environment includes at least one of a living area, a work area, or a recreation area. In an example, at least one device in the plurality of devices is a smart appliance. In an example, the plurality of devices including sensors includes at least one of a temperature sensor, an audio sensor, a motion sensor, or an image sensor. In an example, the IoT devices may contain software sensors. In an example, the person is a member of a plurality of people and the set of data includes data about the plurality of people. In an example, the plurality of people is determined by both a temporal and a proximal relationship between the person and the plurality of people. In an example, the person 110 may be a member of multiple groups.

At operation 310, a behavior is identified based on a comparison of the set of data to a behavior model. In an example, a data element of the set of data includes at least one metadata element containing a characteristic of the data element based on the identified behavior. In an example, the analysis may look for short and long term patterns of behavior. In an example, the behavior model includes a plurality of attributes indicative of a behavior. In an example, the set of data may include data collected from software sensors indicating online activity and the behavior is identified based at least in part on the indication of online activity. In an example, identifying a behavior may include identifying additional factors that are indicative of a change in the behavior of the person. In an example, identifying a behavior may include the user completing a first action rather than a second action.

At operation 315, a recommended action to address the behavior is generated. In an example, the recommended action is based at least in part on the at least one metadata element. In an example, the recommended action is a list of recommended actions. In an example, the recommended action is a reminder. In an example, the recommended action is a text message. In an example, generating a recommended action may include analyzing the identified additional factors indicative of a change to an identified behavior. In an example, generating a recommended action may include analyzing the indication of online activity.

At operation 320, the recommended action is communicated to at least one party influenced by the behavior. In an example, communicating the recommended action includes communicating the recommended action to a third party that has a relationship with the person. In this example, a response to the communication from the third party is received and the recommendation communicated to the at least one party influenced by the behavior is modified based on the response. In an example, data from a sensor may be communicated to a third party. In an example, the data from the sensor may be communicated to a third party that has a relationship to the person. In an example, the data from the sensor may be anonymized and aggregated before being communicated to the third party. In an example, the recommended action may be communicated to the plurality of people. In an example, the recommended action may be communicated to the multiple groups. In an example, the person may restrict communications sent to third parties. In an example, a privacy control list may be maintained to determine the data communicated to the third party.

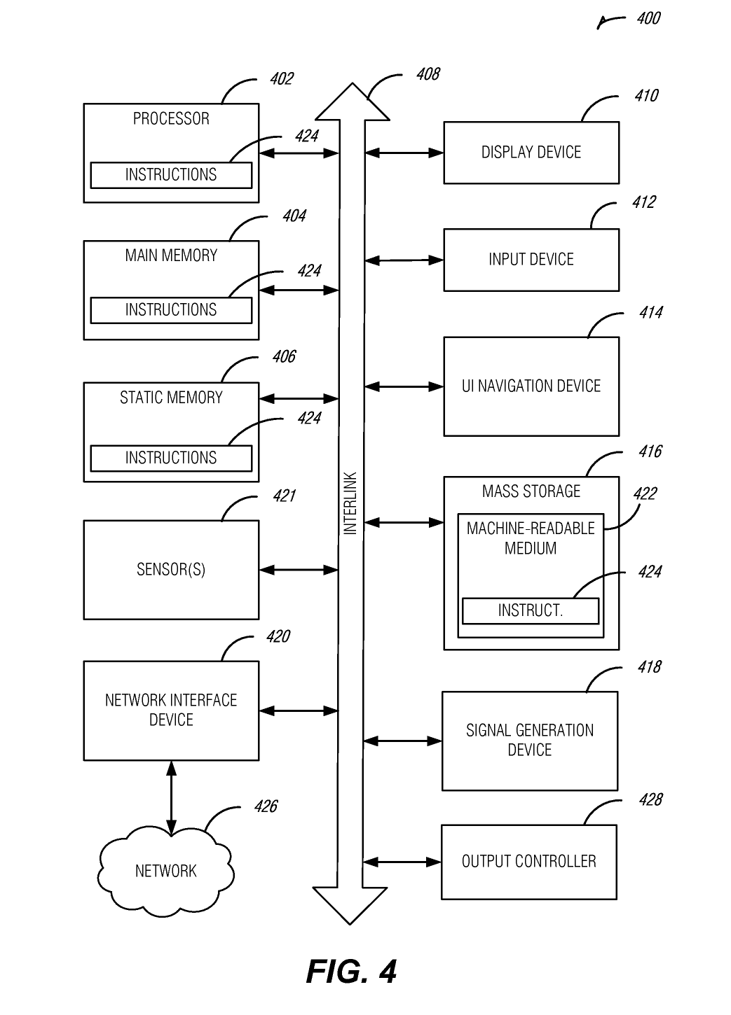

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein may include, or may operate by, logic or a number of components or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer-readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set, at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display device 410, an alphanumeric input device 412 (e.g., a keyboard), and a user interface (UI) navigation device 414 (e.g., a mouse). In an example, the display device 410, input device 412 and UI navigation device 414 may be a touch screen display. The machine 400 may additionally include a mass storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 416 may include a machine-readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine-readable media.

While the machine-readable medium 422 is illustrated as a single medium, the term “machine-readable medium” may include a single medium or multiple media (e.g., a centralized or distributed database, and/or associated caches and servers) configured to store the one or more instructions 424.

The term “machine-readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 424 for execution by the machine 400, and includes digital or analog communications signals or other intangible medium to facilitate communication of such software.

### ADDITIONAL NOTES & EXAMPLES

Example 1 includes subject matter (such as a device, apparatus, or machine) comprising: a data acquisition circuit set to obtain a set of data about an environment and a person from a plurality of devices present in the environment, the plurality of devices including sensors; a behavior modeling circuit set to identify a behavior based on a comparison of the set of data to a behavior model; an action recommendation circuit set to generate a recommended action to address the behavior; and a communication circuit set to communicate the recommended action to at least one party influenced by the behavior.

In Example 2, the subject matter of Example 1 may include, wherein a data element of the set of data includes at least one metadata element containing a characteristic of the data element based on the identified behavior.

In Example 3, the subject matter of Example 2 may include, wherein the recommended action is based at least in part on the at least one metadata element.

In Example 4, the subject matter of any one of Examples 1 to 3 may include, wherein the person is a member of a plurality of people and the set of data includes data about the plurality of people.

In Example 5, the subject matter of Example 4 may include, wherein the plurality of people is determined by both a temporal and a proximal relationship between the person and the plurality of people.

In Example 6, the subject matter of any one of Examples 1 to 5 may include, wherein the plurality of devices including sensors includes at least one of a temperature sensor, an audio sensor, a motion sensor, or an image sensor.

In Example 7, the subject matter of any one of Examples 1 to 6 may include, wherein the environment includes at least one of a living area, a work area, or a recreation area.

In Example 8, the subject matter of any one of Examples 1 to 7 may include, wherein to communicate the recommended action, includes the communication circuit set to: communicate the recommended action to a third party, wherein the third party and the person have a relationship; receive a response to the communication from the third party; and modify the recommended action communicated to the at least one party influenced by the behavior based on the response.

Example 9 includes subject matter (such as a method, means for performing acts, machine readable medium including instructions that when performed by a machine cause the machine to performs acts, or an apparatus to perform) comprising: obtaining, via a transceiver, a set of data about an environment and a person from a plurality of devices present in the environment, the plurality of devices including sensors; identifying a behavior based on a comparison of the set of data to a behavior model; generating a recommended action to address the behavior; and communicating the recommended action to at least one party influenced by the behavior.

In Example 10, the subject matter of Example 9 may include, wherein a data element of the set of data includes at least one metadata element containing a characteristic of the data element based on the identified behavior.

In Example 11, the subject matter of Example 10 may include, wherein the recommended action is based at least in part on the at least one metadata element.

In Example 12, the subject matter of any one of Examples 9 to 11 may include, wherein the person is a member of a plurality of people and the set of data includes data about the plurality of people.

In Example 13, the subject matter of Example 12 may include, wherein the plurality of people is determined by both a temporal and a proximal relationship between the person and the plurality of people.

In Example 14, the subject matter of any one of Examples 9 to 13 may include, wherein the plurality of devices including sensors includes at least one of a temperature sensor, an audio sensor, a motion sensor, or an image sensor.

In Example 15, the subject matter of any one of Examples 9 to 14 may include, wherein the environment includes at least one of a living area, a work area, or a recreation area.

In Example 16, the subject matter of any one of Examples 9 to 15 may include, wherein communicating the recommended action includes: communicating the recommended action to a third party, wherein the third party and the person have a relationship; receiving a response to the communication from the third party; and modifying the recommended action communicated to the at least one party influenced by the behavior based on the response.

Example 17 may include, or may optionally be combined with the subject matter of any one of Examples 1-16 to include subject matter (such as a device, apparatus, or system for context derived behavior modeling and feedback) including at least one machine readable medium including instructions that, when executed by a machine, cause the machine to perform any of Examples 9-16.

Example 18 may include, or may optionally be combined with the subject matter of any one of Examples 1-17 to include subject matter (such as a device, apparatus, or system for context derived behavior modeling and feedback)including a system comprising means to perform any of Examples 9-16.

Example 19 includes subject matter (such as a device, apparatus, or machine) comprising: a receipt means for obtaining a set of data about an environment and a person from a plurality of devices present in the environment, the plurality of devices including sensors; a behavior modeling means for identifying a behavior based on a comparison of the set of data to a behavior model; a recommendation means for generating a recommended action to address the behavior; and a communication means for communicating the recommended action to at least one party influenced by the behavior.

In Example 20, the subject matter of Example 19 may include, wherein a data element of the set of data includes at least one metadata element containing a characteristic of the data element based on the identified behavior.

In Example 21, the subject matter of Example 20 may include, wherein the recommended action is based at least in part on the at least one metadata element.

In Example 22, the subject matter of any one of Examples 19 to 21 may include, wherein the person is a member of a plurality of people and the set of data includes data about the plurality of people.

In Example 23, the subject matter of Example 22 may include, wherein the plurality of people is determined by both a temporal and a proximal relationship between the person and the plurality of people.

In Example 24, the subject matter of any one of Examples 19 to 23 may include, wherein the plurality of devices including sensors includes at least one of a temperature sensor, an audio sensor, a motion sensor, or an image sensor.

In Example 25, the subject matter of any one of Examples 19 to 24 may include, wherein the environment includes at least one of a living area, a work area, or a recreation area.

In Example 26, the subject matter of any one of Examples 19 to 25 may include, wherein communicating the recommended action includes the communication means to: communicate the recommended action to a third party, wherein the third party and the person have a relationship; receive a response to the communication from the third party; and modify the recommended action communicated to the at least one party influenced by the behavior based on the response.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for context derived behavior modeling and feedback, the system comprising:
a data acquisition circuit set to obtain a set of data about an environment and a person from a plurality of devices present in the environment, the plurality of devices including sensors;
a behavior modeling circuit set to identify a behavior based on a comparison of the set of data to a behavior model;
an action recommendation circuit set to generate a recommended action to address the behavior; and
a communication circuit set to communicate the recommended action to at least one party influenced by the behavior.

2. The system of claim 1, wherein a data element of the set of data includes at least one metadata element containing a characteristic of the data element based on the identified behavior.

3. The system of claim 2, wherein the recommended action is based at least in part on the at least one metadata element.

4. The system of claim 1, wherein the person is a member of a plurality of people and the set of data includes data about the plurality of people.

5. The system of claim 4, wherein the plurality of people is determined by both a temporal and a proximal relationship between the person and the plurality of people.

6. The system of claim 1, wherein the plurality of devices including sensors includes at least one of a temperature sensor, an audio sensor, a motion sensor, or an image sensor.

7. The system of claim 1, wherein the environment includes at least one of a living area, a work area, or a recreation area.

8. The system of claim 1, wherein to communicate the recommended action, includes the communication circuit set to:
communicate the recommended action to a third party, wherein the third party and the person have a relationship;
receive a response to the communication from the third party; and
modify the recommended action communicated to the at least one party influenced by the behavior based on the response.

9. A method for context derived behavior modeling and feedback, the method comprising:
obtaining, via a transceiver, a set of data about an environment and a person from a plurality of devices present in the environment, the plurality of devices including sensors;
identifying a behavior based on a comparison of the set of data to a behavior model;
generating a recommended action to address the behavior; and
communicating the recommended action to at least one party influenced by the behavior.

10. The method of claim 9, wherein a data element of the set of data includes at least one metadata element containing a characteristic of the data element based on the identified behavior.

11. The method of claim 10, wherein the recommended action is based at least in part on the at least one metadata element.

12. The method of claim 9, wherein the person is a member of a plurality of people and the set of data includes data about the plurality of people.

13. The method of claim 12, wherein the plurality of people is determined by both a temporal and a proximal relationship between the person and the plurality of people.

14. The method of claim 9, wherein the plurality of devices including sensors includes at least one of a temperature sensor, an audio sensor, a motion sensor, or an image sensor.

15. The method of claim 9, wherein the environment includes at least one of a living area, a work area, or a recreation area.

16. The method of claim 9, wherein communicating the recommended action includes:
communicating the recommended action to a third party, wherein the third party and the person have a relationship;
receiving a response to the communication from the third party; and
modifying the recommended action communicated to the at least one party influenced by the behavior based on the response.

17. At least one machine-readable medium including instructions that, when executed by a machine, cause the machine to perform operations comprising:
obtaining, via a transceiver, a set of data about an environment and a person from a plurality of devices present in the environment, the plurality of devices including sensors;
identifying a behavior based on a comparison of the set of data to a behavior model;
generating a recommended action to address the behavior; and
communicating the recommended action to at least one party influenced by the behavior.

18. The at least one machine-readable medium of claim 17, wherein a data element of the set of data includes at least one metadata element containing a characteristic of the data element based on the identified behavior.

19. The at least one machine-readable medium of claim 18, wherein the recommended action is based at least in part on the at least one metadata element.

20. The at least one machine-readable medium of claim 17, wherein the person is a member of a plurality of people and the set of data includes data about the plurality of people.

21. The at least one machine-readable medium of claim 20, wherein the plurality of people is determined by both a temporal and a proximal relationship between the person and the plurality of people.

22. The at least one machine-readable medium of claim 17, wherein the plurality of devices including sensors includes at least one of a temperature sensor, an audio sensor, a motion sensor, or an image sensor.

23. The at least one machine-readable medium of claim 17, wherein the environment includes at least one of a living area, a work area, or a recreation area.

24. The at least one machine-readable medium of claim 17, wherein communicating the recommended action includes:
communicating the recommended action to a third party, wherein the third party and the person have a relationship;
receiving a response to the communication from the third party; and
modifying the recommended action communicated to the at least one party influenced by the behavior based on the response.
